(19) United States
(12) Patent Application Publication
(10) Pub. No.: US 2025/0383144 A1
(43) Pub. Date: Dec. 18, 2025

(54) AIR SEPARATION METHOD AND PLANT

(71) Applicant: LINDE GMBH, Pullach (DE)

(72) Inventor: Lars KIRCHNER, Pullach (DE)

(21) Appl. No.: 19/108,033

(22) PCT Filed: Aug. 29, 2023
(86) PCT No.: PCT/EP2023/025390

§ 371 Date: Feb. 28, 2025

(30) Foreign Application Priority Data
Sep. 9, 2022 (EP) 22020433.3
Sep. 13, 2022 (EP) 22020438.2

(51) Int. Cl. F25J 3/04

(52) U.S. Cl. CPC F25J 3/04848; F25J 3/04018; F25J 3/04169; F25J 2210/02; F25J 2210/40

(57) ABSTRACT

In this air separation method, compressed air is successively cooled in a cooling step, purified in a purifier and sent to a cryogenic section producing at least one product containing at least one air component. The purifier comprises at least two switchable adsorber vessels, one of them being in adsorption mode. Two sources of compressed air are provided. The first source is an air grid supplying compressed air to further consumers. The second source is a dedicated main air compressor delivering compressed air to the cooling step only. Air portions from both sources are mixed at a mixing point. The air flow to the cryogenic section is controlled by measuring at least one parameter of the air flow upstream or downstream the purifier. According to such measurement, the air flow at the outlet of the main air compressor is set.

In a classical adsorption purifier of a cryogenic air separation unit, air pressure and air flow vary in connection with switching steps in the purifier. In this invention we have a particular type of air supply to the air separation, i.e. a combination of an air grid that supplies other consumers as well and a dedicated main air compressor. Such configuration is, e.g., used, if an existing site, possibly already comprising one or more air separation units already supplied by the grid, is extended by a (further) air separation unit.

The existing capacity of the air grid may be used but may not be sufficient. The standard solution would be using a dedicated main air compressor for the complete air demand of the new air separation unit. In the process of the invention, the existing capacity of the grid is used and just the missing capacity is provided separately by a smaller main air compressor. The two air streams from the two sources are mixed at a mixing point. The question arises, how to control the total air flow in an efficient and stable manner. Similar processes have been disclosed in US 7 645 319 B2, US 2021/278132 A1, US 2017/276428 A1 or US 2021/138387 A1.

The solution to that problem is presented in the independent patent claims. Main feature is to control the main air compressor and not or not only the air from the air grid. The control strategies of the invention ensure the possibility to run the air separation unit with maximum capacity, without taking too much air from grid or loosing air feed during pressurization of the adsorber vessels of the purifier.

In a further embodiment of the invention, the setting of the air flow at the outlet of the main air compressor is performed by controlling the guide vanes of the main air compressor.

Preferably, the air flow from the air grid to the mixing point is set by a flow control valve, which is not controlled by the measuring of at least one parameter of the air flow upstream or downstream the purifier. The flow control valve for the flow from the air grid may even have a fixed position, meaning that a fixed amount of compressed air is fed from the air grid to the mixing point.

In another preferred embodiment, the air flow downstream the purifier is the single parameter measured and used for controlling the air flow. Such method results in a simple and stable control.

In one ore more preferred embodiments, the following parameters are measured and used for controlling the air flow:
air flow downstream the purifier,
air flow upstream the purifier,
air pressure downstream the purifier,
air pressure upstream the purifier.

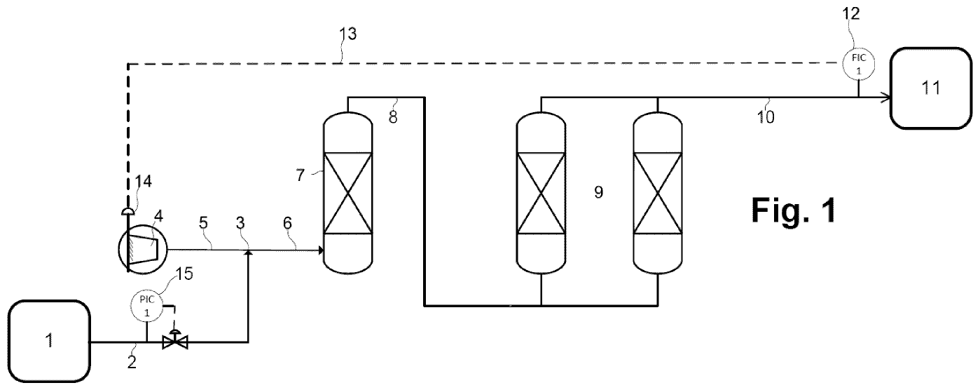

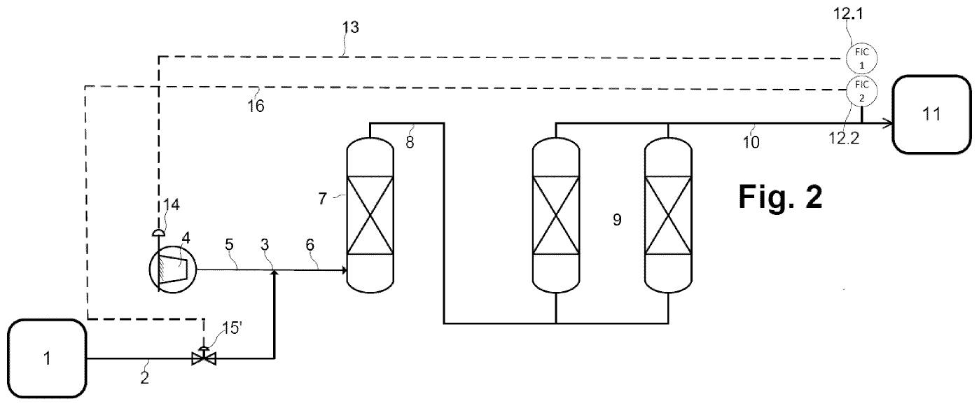

The invention and further details of the invention are now explained on the basis of the attached drawings. FIGS. 1 and 2 show two embodiments of the invention.

In FIG. 1, a first source for pressurized air is a pressurized air grid 1. Via line 2, air from the air grid 1 is transported to a mixing point 3. The second air source for supplying pressurized air to the mixing point 3 is a main air compressor 4 being e.g. a turbocompressor. Pressurized air from the main air compressor 4 is guided by line 5 to the mixing point 3. The mixed air 6 is cooled in a classical direct contact cooler 7 by direct contact with cooling water (the water cycle not being shown in the drawing). Alternatively, the cooling of the air by cooling water may be performed by indirect heat exchange, e.g. in a TEMA heat exchanger (tube and shell).

The pre-cooled air 8 is sent to one of the adsorption vessels of a purifier 9, the other vessel being regenerated. The purifier is operated by TSA (temperature swing adsorption), PSA (pressure swing adsorption) or a combination of both. Purified air 10 is then sent to a cryogenic section comprising the main heat exchanger, the column(s) and turbines of the classical cold part of an air separation plant.

According to the invention, the flow of air 10 to the cryogenic section 11 is measured by a single flow measurement device 12 (FIC1-flow indicator and controller). The measurement is used to set the air flow at the outlet of the main air compressor 4 by sending a control signal via data connection 13 to a setting device 14 of the main air compressor 4. It may thereby control the guide vane angel, the speed or another parameter of the main air compressor influencing the air flow at its outlet.

The air flow 2 in the meaning of the amount of air going the mixing point 3 from the grid may be kept constant or, alternatively vary with the above flow measurement or a different control parameter.

The embodiment is particularly suited for upgrading an air separation site having at least two air separation units being exclusively supplied with pressurized air by the air grid. There may be capacity in the grid that is intended to be used for the further, upgrading air separation plant, but such capacity being not sufficient. The solution according to the invention will be a relatively small main air compressor for the further plant in combination with the grid as shown in the embodiments here. The control method according to the invention results in a stable and economic operation.

Instead of the pressure control device 15 (PID), there could be used an HIC (hand indicating controller) in line 2 setting the flow from the grid to the mixing point just manually.

FIG. 2 uses two FICs 12.1, 12.2; the two FICs may have slightly different set points. The measurement of the air flow in line 10 is the same for FIC1 and FIC2. The effect of FIC1 on the guide vanes 14 of the main air compressor is the same as in FIG. 1. If two controllers FIC1, FIC2 are used, the setpoint for these will be slightly different. Consequently, the controller with the higher setpoint will be linked to the preferred air source (e.g. valve 15 for grid feed). When this source cannot deliver any more, the second air source (e.g. compressor capacity control 14) linked to the controller with the lower setpoint will cut in and compensate for the missing flow. The grid pressure limitation control can be combined with this control scheme. Alternatively, a “split range controller” may be used. Such split range controller acts e.g. from 0% to 50% output on one device only and above 50% output also starts opening the other device.

Alternatives to FIGS. 1 and 2 are pressure control upstream or downstream of the pre-purifier, split range and bias control.

1. An air separation method, wherein compressed air is successively cooled in a cooling step , purified in a purifier and sent to a cryogenic section producing at least one product containing at least one air component, the purifier comprising at least two switchable adsorber vessels, one of them being in adsorption mode, whereby two sources of compressed air are provided, the first source being an air grid supplying compressed air to further consumers, the second source being a dedicated main air compressor delivering compressed air to the cooling step only, air portions from both sources being mixed at a mixing point and the air flow to the cryogenic section being controlled by measuring at least one parameter of the air flow upstream or downstream the purifier and, according to such measurement, setting the air flow at the outlet of the main air compressor

2. The method of claim 1, in which the setting of the air flow at the outlet of the main air compressor is performed by controlling the guide vanes of the main air compressor.

3. The method of claim 1, in which the air flow from the air grid to the mixing point is set by a flow control valve, which is not controlled by the measuring of at least one parameter of the air flow upstream or downstream the purifier.

4. The method of claim 1, in which the air flow downstream the purifier is the single parameter measured and used for controlling the air flow.

5. The method of claim 1, in which one or more of the following parameters are measured and used for controlling the air flow:
air flow downstream the purifier
air flow upstream the purifier
air pressure downstream the purifier
air pressure upstream the purifier.

6. An air separation plant comprising:
a cryogenic section producing at least one product containing at least one air component,
a cooling step for cooling compressed air,
a purifier comprising at least two switchable adsorber vessels for purifying cooled air,
means to send the purified air to the cryogenic section
two sources of compressed air are provided,
the first source being connected to an air grid supplying compressed air to further consumers,
the second source being a dedicated main air compressor delivering compressed air to the cooling step only,
means for mixing air portions from both sources at a mixing point and
control means for controlling the air flow to the cryogenic section by measuring at least one parameter of the air flow upstream or downstream the purifier and, according to such measurement, setting the air flow at the outlet of the main air compressor.

7. The air separation plant of claim 6, in which the control means are capable of setting of the air flow at the outlet of the main air compressor by controlling the guide vanes of the main air compressor.

8. The air separation plant of claim 6, in which the control means are capable of setting the air flow from the air grid to the mixing point by a flow control valve being not controlled by the measuring of at least one parameter of the air flow upstream or downstream the purifier.

9. The air separation plant of claim 6, in which the control means are capable of controlling the air flow by the air flow measurement downstream the purifier as the single parameter measured.

10. The air separation plant of claim 6, in which the control means comprises one or more measurement devices used for controlling the air flow, such measurement devices being capable of measuring one or more of the following parameters:
air flow downstream the purifier
air flow upstream the purifier
air pressure downstream the purifier
air pressure upstream the purifier.

11. A method for upgrading an air separation site already comprising at least two air separation units supplied with pressurized air by an air grid by adding a further air separation plant comprising:
a cryogenic section producing at least one product containing at least one air component,
a colling step for cooling compressed air,
a purifier comprising at least two switchable adsorber vessels for purifying cooled air,
means to send the purified air to the cryogenic section
two sources of compressed air are provided,
the first source being connected to an air grid supplying compressed air to further consumers,
the second source being a dedicated main air compressor delivering compressed air to the cooling step only,
means for mixing air portions from both sources at a mixing point and
control means for controlling the air flow to the cryogenic section by measuring at least one parameter of the air flow upstream or downstream the purifier and, according to such measurement, setting the air flow at the outlet of the main air compressor,
the further air separation plant being operated according to claim 1.

12. A method for upgrading an air separation site already comprising at least two air separation units supplied with pressurized air by an air grid by adding a further air separation plant comprising:
a cryogenic section producing at least one product containing at least one air component,
a cooling step for cooling compressed air,
a purifier comprising at least two switchable adsorber vessels for purifying cooled air,
means to send the purified air to the cryogenic section
two sources of compressed air are provided,
the first source being connected to an air grid supplying compress air to further consumer,
the second source being a dedicated main air compressor delivering compressed air to the cooling step only,
means for mixing air portion from both sources at a mixing point and
control means for controlling the air flow to the cryogenic section by measuring at least one parameter of the air flow upstream or downstream the purifier and, according to such measurement, setting the air flow at the outlet of the main air compressor,
the further air separation being an air separation plant according to claim 6.
